(19) United States
(12) Patent Application Publication
(10) Pub. No.: US 2025/0045684 A1
(43) Pub. Date: Feb. 6, 2025

(54) SYSTEMS AND TECHNIQUES FOR DYNAMIC MOBILE MANAGEMENT USING COMPUTER VISION AND NAVIGATION SENSORS

(71) Applicant: Pied Parker, Inc., Sacramento, CA (US)

(72) Inventors: Gianni Rosas-Maxemin, Sacramento, CA (US); Jeremy Strickland, Sacramento, CA (US); Rishi Kumar, Sacramento, CA (US); George Azzi, Sacramento, CA (US); Robert Mazzola, Sacramento, CA (US)

(21) Appl. No.: 18/717,934

(22) PCT Filed: Dec. 7, 2022
(86) PCT No.: PCT/US2022/052183

§ 371 Date: Jun. 7, 2024

Related U.S. Application Data
(60) Provisional application No. 63/287,022, filed on Dec. 7, 2021.

(51) Int. Cl. G06Q 10/0833; G01S 17/88; G01S 19/48; G01S 19/49

(52) U.S. Cl. CPC G06Q 10/0833; G01S 17/88; G01S 19/485; G01S 19/49

(57) ABSTRACT

The present disclosure generally relates to tracking shipments in a dynamic, mobile environment, more specifically, to tracking shipments using computer vision and navigation sensors. Container yards remain notoriously inefficient as companies waste time and resources searching for shipping containers and inventory poorly located in the container yard. Lack of timely location of assets can lead to misaligned inbound processes, incomplete assembly, missed deliveries and spoiled goods. Many companies have a large gap in visibility and management capabilities between in-transit inventory and the warehouse. Described are systems and techniques for locating and identifying shipping containers or open parking spots in a container yard using computer vision and machine learning algorithms, a camera, and position, navigation, and timing (PNT) sensors.

### CROSS REFERENCE TO RELATED APPLICATIONS

This application is a US National Phase of International Application No. PCT/US2022/052183, filed Dec. 7, 2022, which claims priority to U.S. Application No. 63/287,022, filed Dec. 7, 2021, the contents of which are incorporated herein by reference in their entireties.

### BACKGROUND

### 1. Technical Field

The present disclosure generally relates to tracking shipments in a dynamic, mobile environment, more specifically, to tracking shipments using computer vision and navigation sensors.

### 2. Introduction

A container yard (also yard) is a designated storage area for containers in a terminal or dry port before they are loaded or off-loaded from a ship. A container yard is used for aligning containers for loading on a ship and for storing off-loaded containers till they are shifted to the rail yard, Container Freight Station (CFS), or delivered to the consignee. Freight tracking visibility has improved significantly in recent years as companies understand the utmost importance of determining where their freight is at any given time. Once freight reaches the warehouse or distribution center, a warehouse management system takes over. Unfortunately, there is a visibility gap that creates a virtual black hole in many supply chains: the yard. Many companies are now realizing that they need better last-mile visibility into inbound shipments to manage the flow of traffic for manufacturing and distribution sites. Disruptions such as COVID-19 have exacerbated the challenges of managing congested yards, highlighting notorious inefficiencies of manual operations.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example system for locating shipping containers, according to some examples of the present disclosure;

FIG. 2 illustrates another example system for locating shipping containers, according to some examples of the present disclosure;

FIG. 3 illustrates an example communication system for locating shipping containers, according to some examples of the present disclosure;

FIG. 4 illustrates an example remote location in a container yard, according to some examples of the present disclosure;

FIG. 5 illustrates an example process for locating shipping containers, according to some examples of the present disclosure;

FIG. 6 illustrates another example process for locating shipping containers, according to some examples of the present disclosure; and

FIG. 7 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

One aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Container yards can be vast spaces, used to accommodate containers before they are packed and shipped to the port. The purpose of having a yard can be to minimize the usage of the valuable space at the port and create a separate space for their storage and maintenance. Furthermore, container yards can be used to store shipping containers (also containers, freight containers, trailers, intermodal containers, crates or other variations of terms representing large objects for transporting materials) just before they are shipped off by the shipping line. In some aspects, container yards may be located near a terminal or an inland (dry) port. Shipping containers can be moved within a container yard by a yard rig (also terminal tractor, shunt truck, container truck, spotter truck, spotting tractor, yard truck, yard shifter, yard dog, yard goat, yard horse, yard bird, yard jockey, hostler, mule). In some aspects, companies may utilize autonomous vehicle technology with yard rigs that maneuver in a container yard (e.g., which may be a less complex environment compared to an autonomous vehicle environment). In some examples, Light Detection and Ranging (LiDAR), radar, cameras, and other sensors may be fitted to yard rigs to give them 360-degree awareness. Although this technology may improve and automate the movement of shipping containers in a yard, it still may not help with solving the issue of tracking and locating them.

Aspects of the disclosed invention provide solutions for locating shipping containers in a container yard by utilizing at least one of computer vision, machine learning algorithms, navigation sensors, or a combination thereof. In some aspects, computer vision and machine learning algorithms may be implemented on a yard rig or a drone to read identifying information on a shipping container such as a trailer ID or other unique identifying information. In some examples, computer vision and machine learning algorithms may be used to identify open parking spots or spaces to store shipping containers. In some instances, position, navigation and timing (PNT) sensors, a camera, machine learning algorithms, and computer vision algorithms may be used to determine location information of shipping containers and open parking spots. In some aspects, a locator system may be used to send location information of an identified shipping container and transmit the location information to an external location such as the cloud or a remote location.

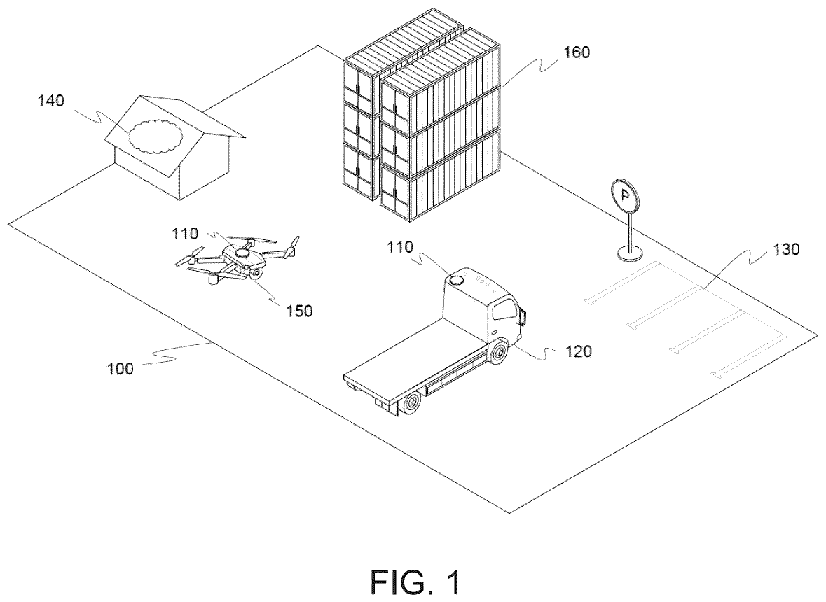

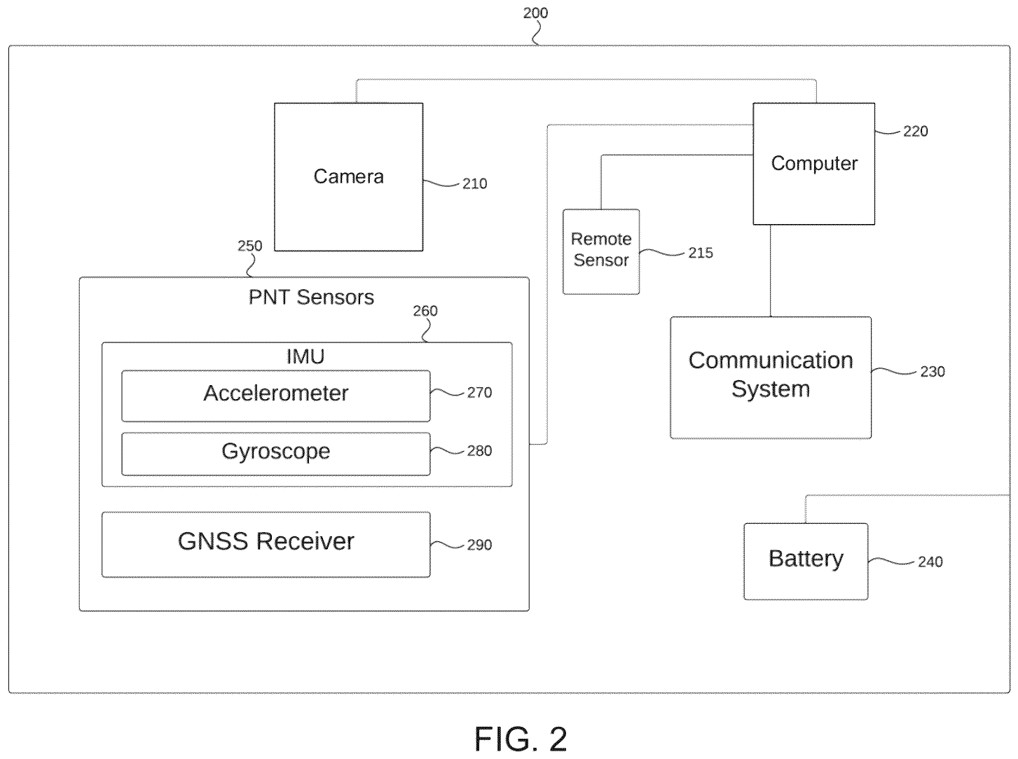

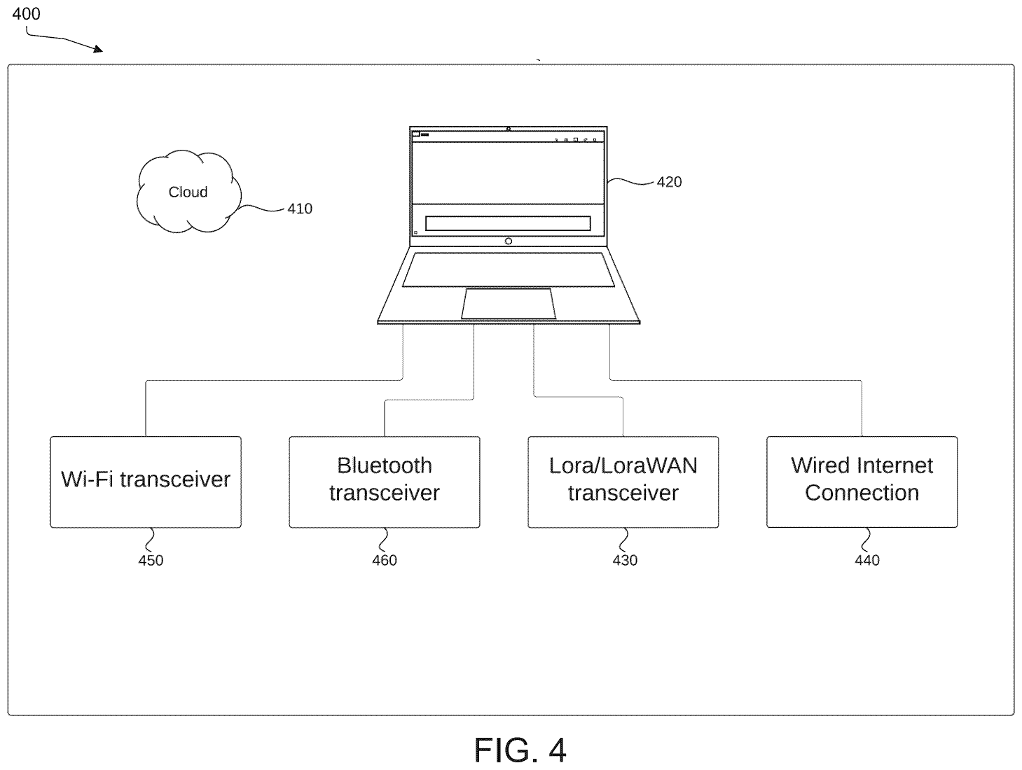

FIG. 1 illustrates an example of a system in which a shipping container locator process may be implemented. The container yard 100 includes one or more shipping containers 160, one or more parking spots 130, remote location 140, yard rig 120, and drone 110. The yard rig 120 and drone 150 each include locator system 110. In some aspects, the size (e.g., dimensions in three-dimensional space) of container yard 100 may vary depending on the number of shipping containers 160 and open parking spots 130. In some examples, container yard 100 may include one or more yard rigs 120 which can be used to locate and move one or more shipping containers 160. In some cases, container yard 100 may include one or more parking spaces 130 which may be used to store (e.g., place at the location of the parking spaces 130) shipping containers 160. In some aspects, shipping containers 160 may be stacked on top of each other to maximize storage in container yard 100 or stored in another stackable method. Those skilled in the art will appreciate different methods of stacking shipping containers 160 in a container yard 100. In some examples, the number of yard rigs 120 in a container yard 100 may vary based on the container yard size 100. The container yard 100 may also include one or more drones 150 for locating one or more shipping containers 160 or open parking spots 130. In some cases, yard rig 120 or drone 150 may include a locator system 110 to locate shipping containers 160 or open parking spots 130 in container yard 100 and transmit the location information to a remote location 140. For example, locator system 110 may transmit location information to remote location 140 via an RF signal (not shown). In some instances, examples of RF signal types may include, but are not limited to, Ultra-Wideband (UWB), Li-Fi, cellular, WI-FI, Wireless Local Area Network (WLAN), Low Power Wide Area Network (LPWAN), Bluetooth®, satellite-based (e.g., SpaceX Starlink, Amazon Kuiper), and infrared. Those skilled in the art will appreciate additional examples of RF signal types for communications (e.g., locator system 110 communicating with remote location 140). In some aspects, remote location 140 may be a physical location such as an office or building. In some instances, remote location 140 may be the cloud (e.g., remote servers accessible via the internet) for uploading data (e.g., locator system 110 may upload data to the cloud). In some cases, the cloud can be servers that are accessible over the Internet in addition to the software and databases that run on those servers. The remote location 140 will be discussed in further detail in FIG. 4 below. In some aspects, locator system 110 may include computer vision and machine learning algorithms to read identifying information on shipping containers 160 or open parking spots 130. In some cases, locator system 110 may include navigation sensors to locate the one or more shipping containers or one or more open parking spots. The locator system 110 (e.g., attached to the one or more yard rigs 120 or one or more drones 150) may allow real-time visibility of the location of every shipping container 160 in the container yard 100. This process will be described in further detail in FIG. 2 below.

FIG. 2 illustrates another example of a system in which a shipping container locator process may be implemented. The locator system 200 (e.g., locator system 110 as illustrated in FIG. 1) includes camera 210, computer 220, remote sensor 215, communication system 230, battery 240, and PNT sensors 250. The PNT sensors 250 includes Inertial Measurement Unit (IMU) 260 and GNSS Receiver 290. The IMU 260 includes one or more accelerometers 270 and one or more gyroscopes 280. In some aspects, locator system 200 may be attached to a yard rig or drone (e.g., yard rig 120 or drone 150 as illustrated in FIG. 1). In some examples, locator system 200 may be used to locate and identify shipping containers (e.g., shipping containers 160 as illustrated in FIG. 1) in a container yard using computer vision and/or machine learning algorithms combined with position, navigation and timing (PNT) sensors 250. In some examples, the designated set of coordinates or location (e.g., latitude and longitude) of every shipping container and parking spot (e.g., one or more shipping containers 160 and one or more parking spots 130 as illustrated in FIG. 1) may be stored (e.g., stored in memory of computer 220) in locator system 200 and accessible by computer 220. In some aspects, shipping containers can be moved throughout the container yard (e.g., container yard 100 as illustrated in FIG. 1) and may be lost (e.g., the location is not known or cannot be determined within the container yard). In some aspects, locator system 200 may determine the location of the shipping containers and prevent them from being lost within the container yard. In some cases, locator system 200 may include a mapping of the container yard (e.g., stored in computer system 220). In other words, locator system 200 may include stored data regarding the container yard including, but not limited to, pavement markings, street markings, lane markings, and dimensions. In some cases, locator system 200 may be powered by a designated battery 240 or connected to another power source (not shown) that can power all the components of locator system 200. An examples of another power source may include, but is not limited to, the battery power of the yard rig or drone the locator system 200 is attached to. In some aspects, PNT sensors 250 may include an Inertial Measurement Unit (IMU) 260 which can include one or more accelerometers 270 and one or more gyroscopes (gyros) 280. In some examples, PNT sensors 250 may be used by computer 220 to determine the position in three-dimensional (3D) space of the object (e.g., yard rig 120 or drone 150 as illustrated in FIG. 1), they are attached to. As described herein, an object's position describes where the object is located in three-dimensional space (e.g., a rocket's position mid-flight above the Earth's surface would be in three-dimensional space) and the orientation (e.g., pose) of the object. As described herein, an object's location describes where an object is located on the Earth's surface (e.g., using latitude and longitude coordinates). In some cases, the number of accelerometers 270 and gyros 280 may vary depending on the type of sensors in order for accelerometers 270 to measure acceleration in relation to three coordinate axes and the gyros 280 to measure angular velocity around three coordinate axes. The three coordinate axes may represent three-dimensional space. Examples of systems with three coordinate axes may include, but are not limited to, a Cartesian coordinate system, a cylindrical coordinate system, and a spherical coordinate system. For example, a single-axis accelerometer 270 can measure along a single axis, in which case at least three accelerometers 270 may be needed to measure acceleration along three axes for three-dimensional space. In another example, a three-axis accelerometer 270 can measure along all three axes so only one may be needed. This may also apply to single-axis or three-axis gyroscopes 280. Examples of accelerometer 270 types may include, but are not limited to, Microelectromechanical Systems (MEMS), resistive, capacitive, fiber optic, servo/force balance, vibrating quartz, and piezoelectric. Examples of gyroscope 280 types may include, but are not limited to, MEMS, ring-laser, fiber-optic, vibration and fluid. In some instances, computer 220 may use accelerometer 270 and gyroscope 280 data to continuously calculate (e.g., by dead reckoning which is the process of calculating a current position using a previously determined position while utilizing estimates such as speed and direction) the position and orientation of the yard rig or drone it is attached to (e.g., locator system 200 may be attached to the yard rig or drone and includes accelerometer 270 and gyroscope 280). The computer 220 may use the position information to derive a location (e.g., a geographic coordinate such as a latitude and longitude) of the yard rig or done. The computer 220 combined with the IMU 260 can operate as an inertial navigation system (INS), by the mathematical functions of double integrating the accelerometer 270 data with respect to time to get position information and single integrating the gyroscope 280 data with respect to time to get orientation information. The calculated position (e.g., location and orientation) derived from the accelerometers 270 and gyroscopes 20 would be relative to a starting position of the yard rig or drone, which may be derived from Global Navigation Satellite System (GNSS) receiver (Rx) 290 or set manually by the computer 220. In other words, in order for the IMU 260 to calculate a current position, it must first have an accurate initial position since IMU 260 is calculating changes in position based on an initial position. As discussed above, a location such as latitude and longitude coordinates may be derived by computer 220 from the position information derived from IMU 260. In some examples, the initial position may be determined when locator system 200 is initially powered on or at a later time when GNSS receiver 290 or computer 220 determines the current location. In some examples, PNT sensors 250 may include a GNSS receiver 290. Examples of satellite signals the GNSS receiver 290 can receive may include, but are not limited to, GPS, GLONASS, BeiDou, and Galileo. The GNSS receiver 290 can calculate the location of the yard rig or device it is attached to via satellites which can provide signals from space that transmit positioning and timing data to GNSS receiver 290. Some advantages of disclosed examples are computer 220 uses IMU 260 to calculate location without the need of an external signal. The GNSS receiver 290 also calculates a location but instead relies on external satellite signals. Accelerometers 270 and gyroscopes 280 may have errors such as bias and scale factor errors that interfere with accurately calculating position. Sensor fusion algorithms, including, but not limited to, Kalman filtering algorithms may be used to fuse GNSS receiver 290 data with IMU 260 data for improved position determination accuracy. In other words, Kalman filtering provides the benefits of both GNSS receiver 290 and IMU 260. In some examples, IMUs 260 often have fast update rates compared to GNSS receivers 290. However, IMUs 260 may have errors such as bias and scale factor errors that may degrade the accuracy of IMU 260 over long periods of time compared to GNSS receivers 290. The Kalman filter based sensor fusion algorithm can combine IMU 160 and GNSS receiver 290 to essentially combine the strengths (e.g., the fast update rate of IMU 160 and accuracy of GNSS receiver 290) of both sensors by providing a high update rate that does not significantly degrade over time. The Kalman filter would also account for scenarios in which GNSS receiver 290 has issues with receiving a satellite signal. If the GNSS receiver 290 is not receiving a satellite signal, the position calculation using Kalman filtering would weigh the IMU 260 data more heavily than the GNSS receiver 290 data. Another sensor fusion algorithm is a Particle filter which can provide another method of combining IMU 260 and GNSS receiver 290 data but is more computationally heavy compared to a Kalman filter. As discussed above, the location determination would be performed by computer 220 by utilizing the navigation data from both GNSS Rx 290 and IMU 260. In some aspects, PNT sensors 250 may also include other sensor types to augment position information. Additional PNT sensor examples include, but are not limited to, barometers and magnetometers. Those skilled in the art will appreciate additional examples of navigation sensors that may be used to augment position information.

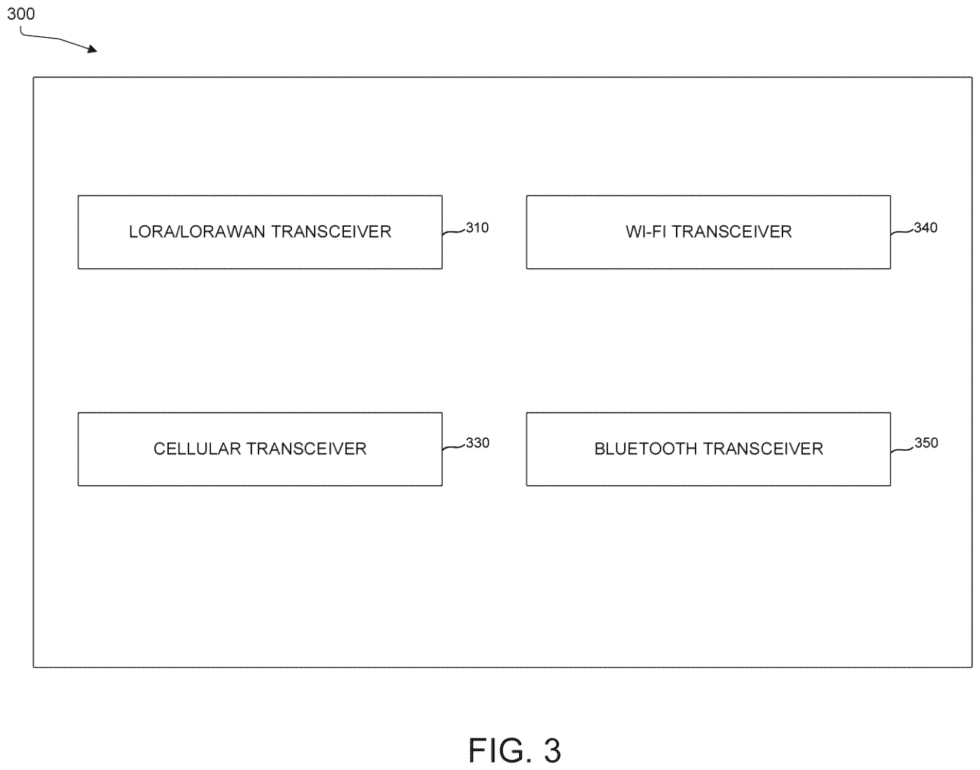

As described above, PNT sensors 250 combined with computer 220 may provide location information of the device they are attached to (e.g., yard rig 110 or drone 150 as illustrated in FIG. 1). The next step can be to calculate the location and identification information of the shipping containers or open parking spots in the yard. In some examples, a camera 210 may be attached to a mechanical gimbal structure such that it has 360-degree visibility. In other words, the camera 210 may be able to capture images and video of surrounding environments. In some examples, the computer 220 may use image and video data captured by camera 210 and process the data using computer vision and machine learning algorithms, which may be trained to detect particular features of the surrounding environment such as shipping container and open parking spot identification features. In other words, computer 220 may identify shipping containers and open parking spots in a yard using computer vision and machine learning algorithms applied to identification features of the shipping container and open parking spots which are captured by camera 210. Examples of shipping container identification features may include, but are not limited to, a trailer ID and the appearance of the shipping container (e.g., decals, shipping container damage, shipping container customizations). Examples of open parking spot identification features may include, but are not limited to, alphanumeric identifiers in the parking spot and parking lot striping features. Those skilled in the art will appreciate additional examples of shipping container and open parking spot identification features. In some examples, a machine learning (ML) model may be trained/tuned based on training data collected from positive recognition (e.g., of shipping containers or open parking spots), false recognition, and/or other criteria. In some aspects, the ML model may be a deep neural network, Bayesian network, and/or the like and/or combinations thereof. Although various types of ML models may be deployed to refine some aspects for identifying whether or not a shipping container or open parking spot is identified, in some aspects, one or more ML-based classification algorithms may be used. Such classifiers may include but are not limited to: MobileNet object detector, a Multinomial Naïve Bayes classifier, a Bernoulli Naïve Bayes classifier, a Perceptron classifier, a Stochastic Gradient Descent (SGD) Classifier, and/or a Passive Aggressive Classifier, and/or the like. In addition, the ML models may be configured to perform various types of regression, for example, using one or more various regression algorithms, including but not limited to: Stochastic Gradient Descent Regression, and/or Passive Aggressive Regression, etc. In some examples, computer 220 may contain all the machine learning and computer vision algorithms stored in memory on computer 220. In some examples, computer 220 may use a communication system 230 to obtain computer vision and machine algorithms from an external source. The communication system 230 will be discussed in further detail in FIG. 3 below.

As discussed above, in some examples computer 220 may use machine learning and computer vision algorithms on image and video data captured by camera 210 to identify shipping containers and open parking spots in a container yard. The next remaining step may be determining the location of the shipping containers and open parking spots in a container yard.

In some examples, a remote sensor 215 combined with a camera 210 may be used by computer 220 to calculate the distance of a shipping container or an open parking spot relative to the locator system 200 (e.g., relative to the position of the camera 210, remote sensor 215, and computer 220). In some examples, remote sensor 215 may be a LiDAR sensor. In some cases, LiDAR works by emitting pulsed light waves into the surrounding environment. These pulsed light waves bounce off surrounding objects and return to the remote sensor 215. A LIDAR sensor can use the time it took for each pulse to return to the sensor to calculate the distance it traveled. In some examples, remote sensor 215 may be other types of sensors capable of measuring distance including, but not limited to, ultrasonic, infrared, and time-of-flight (TOF) sensors. Those skilled in the art will appreciate additional examples of distance measuring sensors. In some examples, camera 210 may include a remote sensor 215, or remote sensor 215 may be an external component. As discussed above, in some examples camera 210 may be attached to a mechanical gimbal capable of electronic control for rotating camera 210 360-degrees. The computer 220 may be able to control the rotation of camera 210 as well as read the current direction camera 210 is pointed (e.g., the orientation of camera 210). In some cases, computer 220 may use data from the camera's 210 orientation as well as distance information from remote sensor 215 to determine the direction and distance of a shipping container or open parking spot relative to the position (e.g., location and orientation) of the yard rig or drone the locator system 200 is attached to. Since computer 220 may calculate the location of the yard rig or drone the locator system 200 is attached to (e.g., using the data from PNT sensors 250), and also the direction and distance of a shipping container relative to the yard rig or drone the locator system 200 is attached to, the computer may also calculate the location of the shipping container. In some examples, this calculation may be done with vector mathematics. As discussed above, in some examples, the location may be a geographic coordinate using latitude and longitude or another type of coordinate system to indicate the location of the shipping containers in the yard. The same principle may apply to determine the location of open parking spots. As a result of this process, the locator system 200 can continuously scan the entire yard (e.g., as the yard rig or drone traverses the entire yard) and consequently the computer may determine location and identification information of every shipping container and open parking spot in the yard. As discussed above in FIG. 1, there may be one or more yard rigs and one or more drones to cover the entire area of the yard to locate and identify all the shipping containers and open parking spots.

The communication system 230 may be used to transmit information pertaining to the shipping containers and open parking spots to a remote location. In some examples, the transmitted information may include, but is not limited to, location and identification information of shipping containers or open parking spots, and time stamps corresponding to when shipping containers or open parking spots were identified. In some examples, captured image and video data may be transmitted by communication system 230. The communication system 230 will be discussed in further detail in FIG. 3 below.

FIG. 3 illustrates an example communication system 300 for locating shipping containers, according to some examples of the present disclosure. In some aspects, communication system 300 can transmit data from a locator system (e.g., locator system 200 as illustrated above in FIG. 2) to a remote location (e.g., remote location 140 as illustrated in FIG. 1). The remote location will be described in further detail in FIG. 4 below. Examples of a remote location may include, but are not limited to, the cloud or a physical location capable of receiving an RF signal. In some aspects, communication system 300 may include a Long Range/Long Range Wide Area Network (LoRa/LoRaWAN) transceiver 310 which can cover both LoRa and LoRaWAN communication technologies. In some cases, LoRa may be a radio modulation technology for wireless LAN networks in the category of low power wide area (LPWA) network technologies. In some examples, LoRaWAN can be a network (protocol) using LoRa. In some aspects, LoRa can be a proprietary radio modulation technology (e.g., owned by the company Semtech) and can function with only the stack's physical layer. The LoRa technology may use a proprietary Chirp Spread Spectrum (CSS) modulation technology that makes the low power long-range transmission possible over the unlicensed ISM radio band. In some examples, LoRaWAN may be the communication protocol and system architecture for a network. The LoRaWAN may operate with the media access control (MAC) layer and application layer of the LoRa protocol stack and can be open source and managed by the LoRa alliance.

As discussed above in FIG. 2, in some examples, position and identification information of shipping containers and open parking spots may be transmitted by communication system 300 to a remote location. In some aspects, image and video data may be transmitted by communication system 300 to a remote location. This data may be low in bandwidth since it may comprise primarily text data. In some cases, LoRaWAN may be suitable for transmitting small size data payloads over long distances. In some aspects, LoRa modulation can provide a significantly greater communication range with low bandwidths than other competing wireless data transmission technologies. The communication system 300 may also include a cellular transceiver 330 for communications with cellular network standards such as 4G, Long Term Evolution (LTE) and 5G. In some cases, WI-FI transceiver 340 and Bluetooth® transceiver 350 may be used for Bluetooth® (i.e., Bluetooth® and Bluetooth® Low Energy) and WI-FI signals, respectively. In some examples other communication standards such as Zigbee, Ultra-Wideband (UWB) and NFC may be used by the communication system 300. Those skilled in the art will appreciate additional communication technologies that may be used by communication system 300.

FIG. 4 illustrates an example remote location 400 in a container yard, according to some examples of the present disclosure. In some aspects, remote location 400 may be a physical location which may be capable of receiving RF signals from a locator system (e.g., locator system 110 as illustrated in FIG. 1). In some instances, examples of a remote location 400 may include, but are not limited to, an office in close proximity to the container yard, or another physical location at a large distance away from the container yard capable of receiving RF signals from the locator system (e.g., locator system 110 that may be attached to a yard rig 120 or drone 150 as illustrated in FIG. 1). In some cases, remote location 400 may include a computer 420 connected to at least one of a WI-FI transceiver 450, Bluetooth® transceiver 460, LoRa/LoRaWAN transceiver 430 or a combination thereof capable of receiving those types of respective RF signals in addition to a wired internet connection 440. In some cases, remote location 400 may be the cloud 410 (e.g., remote servers accessible via the internet) which may communicate (e.g., send and receive data) with the communication system (e.g., communication system 230 as illustrated in FIG. 2) of the locator system.

As discussed above, in some examples, remote location 400 may receive identification and position information of shipping containers and open parking spots (e.g., shipping containers 160 and open parking spots 130). In some aspects, remote location 400 may receive image and video data of the environments captured by the locator system. In some cases, computer 420 may use machine learning and computer vision algorithms on the received image and video data to determine the identification and position information of shipping containers and open parking spots. In other words, in some cases computer 420 of remote location 400 may determine identification and position information of shipping containers and open parking spots (e.g., based on received image and video data) instead of the computer (e.g., computer 220 as illustrated in FIG. 2) of the locator device.

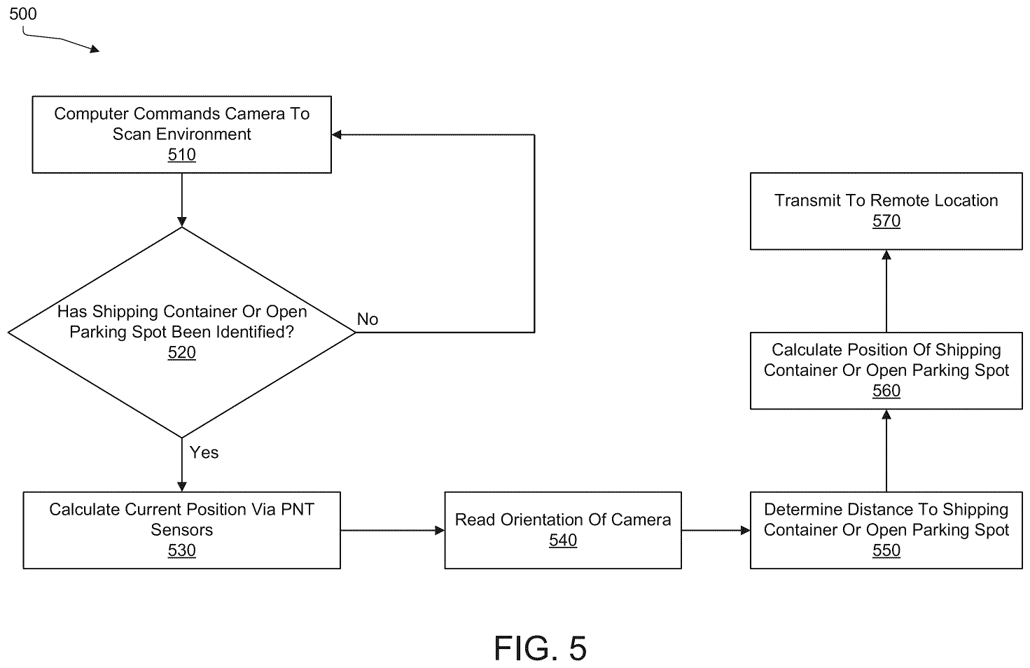

FIG. 5 illustrates an example of a process 500 for locating shipping containers. In some cases, the process 500 may be performed by the locator system as described above in FIG. 1 and FIG. 2. The process 500 begins at block 510 for the computer to command the camera to scan the environment. For example, the camera (e.g., camera 210 as illustrated in FIG. 2) may be mounted on an electronically controllable gimbal capable of capturing the surrounding environment up to 360-degrees. In some examples, the camera may scan the surrounding environment automatically. In some cases, the computer (e.g., computer 220 as illustrated in FIG. 2) may command (e.g., via data commands) the camera to scan the surrounding environment.

The process 500 continues to decision block 520 where a determination is made whether or not a shipping container or open parking spot has been identified. In some cases, the identification of a shipping container or open parking spot may be determined by the computer (e.g., computer 220) using machine learning and computer vision algorithms. If a determination is made that a shipping container or open parking spot has not been identified, the process 500 returns to block 510. If a determination is made that a shipping container or open parking spot has been identified the process 500 continues to block 530.

At block 530, the process 500 may calculate a current position using PNT sensors (e.g., PNT sensors 250 as illustrated above in FIG. 2). The process 500 then continued to block 540 to read the orientation of the camera. In other words, the computer may read (e.g., receive data as an input) the orientation or direction of the camera that is pointing to the identified shipping container or open parking spot from decision block 520. The orientation of the camera may be used to determine the location of the identified shipping container or open parking spot. Next, the process 500 continues to block 550 to determine the distance to the shipping container or open parking spot relative to, or away from, the locator system (e.g., locator system 110). In some embodiments, the locator system may be attached to a yard rig or drone (e.g., yard rig 120 or drone 150). As discussed above, in some examples the distance may be calculated using a remote sensor such as a LIDAR sensor. In some cases, block 540 and block 550 may also be reversed in order for the locating process.

At block 560 the process 500 continues to calculate the position of the identified shipping container or open parking spot. The computer can determine the location of the yard rig or drone the locator system is attached to from the PNT sensors. The camera orientation combined with the distance information (e.g., the distance the shipping container or open parking spot is from the locator system) derived from the remote sensor may provide enough data for the computer to calculate a position of the identified shipping container or open parking spot. The process 500 then continues to block 570 to transmit the identification and location information of the shipping container or open parking spot to a remote location (e.g., remote location 400 as illustrated in FIG. 4).

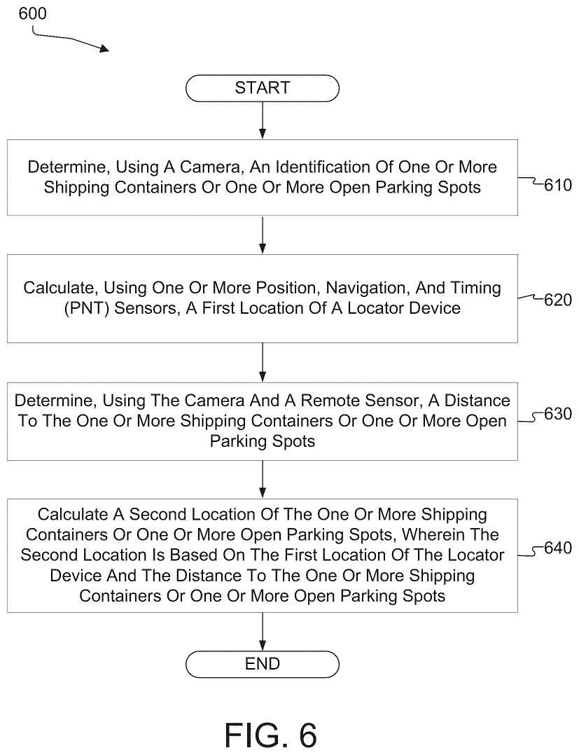

FIG. 6 illustrates another example of a process 600 for locating shipping containers. At block 610, the process 600 includes determining, using a camera, an identification of one or more shipping containers or one or more open parking spots. For example, a camera 210 may use identification features as discussed above to identify one or more shipping containers 160 or open parking spots 130.

At block 620, the process 600 includes calculating, using one or more position, navigation, and timing (PNT) sensors, a first location of a locator device. For example, PNT sensors 250 may be used to determine the location of a locator device (e.g., locator system 110 or locator system 200).

At block 630, the process 600 includes determining, using the camera and a remote sensor, a distance to the one or more shipping containers or one or more open parking spots. For example, camera 210 and remote sensor 215 may be used to determine a distance to one or more shipping containers 160 or open parking spots 130.

At block 640, the process 600 includes calculating a second location of the one or more shipping containers or one or more open parking spots, wherein the second location is based on the first location of the locator device and the distance to the one or more shipping containers or one or more open parking spots. For example, the second location may be the distance from the locator system 110 (also locator system 200) and the shipping containers 160 or the distance from locator system 110 and the open parking spots 130. The locator system may be attached to a yard rig 120 or drone 150.

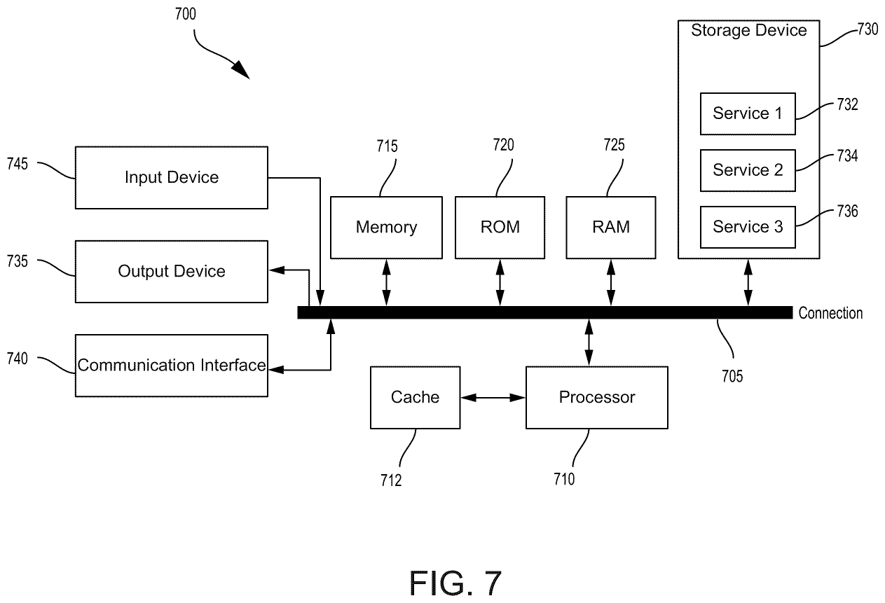

FIG. 7 illustrates an example processor-based system with which some aspects of the subject technology can be implemented. For example, processor-based system 700 can be any computing device making up, or any component thereof in which the components of the system are in communication with each other using connection 705. Connection 705 can be a physical connection via a bus, or a direct connection into processor 710, such as in a chipset architecture. Connection 705 can also be a virtual connection, networked connection, or logical connection.

In some embodiments, computing system 700 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 700 includes at least one processing unit (Central Processing Unit (CPU) or processor) 710 and connection 705 that couples various system components including system memory 715, such as Read-Only Memory (ROM) 720 and Random-Access Memory (RAM) 725 to processor 710. Computing system 700 can include a cache of high-speed memory 712 connected directly with, in close proximity to, or integrated as part of processor 710.

Processor 710 can include any general-purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms known to those of skill in the art. In some instances, multimodal systems can enable a user to provide multiple types of input/output to communicate with computing system 700. Computing system 700 can include communications interface 740, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 740 may also include one or more Global Navigation Satellite System (GNSS) receivers or transceivers that are used to determine a location of the computing system 700 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 730 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/RcRAM), Phase Change Memory (PCM), Spin Transfer Torque RAM (STT-RAM), another memory chip or cartridge, and/or a combination thereof.

Storage device 730 can include software services, servers, services, etc., that when the code that defines such software is executed by the processor 710, it causes the system 700 to perform a function. In some embodiments, a hardware service that performs a particular function can include the software component stored in a computer-readable medium in connection with the necessary hardware components, such as processor 710, connection 705, output device 735, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

### Selected Examples

### Illustrative Examples of the Disclosure Include

Aspect 1. A system comprising: at least one memory; and at least one processor coupled to the at least one memory, the at least one processor configured to: determine, using a camera, an identification of one or more shipping containers or one or more open parking spots; calculate, using one or more position, navigation, and timing (PNT) sensors, a first location of a locator device; determine, using the camera and a remote sensor, a distance to the one or more shipping containers or one or more open parking spots; and calculate a second location of the one or more shipping containers or one or more open parking spots, wherein the second location is based on the first location of the locator device and the distance to the one or more shipping containers or one or more open parking spots.

Aspect 2. The system of Aspect 1, wherein the remote sensor is a Light Detection and Ranging (LiDAR) sensor.

Aspect 3. The system of any of Aspects 1-2, wherein the one or more PNT sensors comprises at least one of an inertial measurement unit (IMU), a Global Navigation Satellite System (GNSS) receiver, or a combination thereof.

Aspect 4. The system of any of Aspects 1-3, wherein the locator device is attached to a yard rig.

Aspect 5. The system of any of Aspects 1-4, wherein the locator device is attached to a drone.

Aspect 6. The system of any of Aspects 1-5, wherein the at least one processor is further configured to: transmit, using a communication system, the identification and the second location of the one or more shipping containers or open parking spots to a remote location.

Aspect 7. The system of any of Aspects 1-6, wherein the camera is mounted on an electronically controllable mechanical gimbal.

Aspect 8. A method comprising: determining, using a camera, an identification of one or more shipping containers or one or more open parking spots; calculating, using one or more position, navigation, and timing (PNT) sensors, a first location of a locator device; determining, using the camera and a remote sensor, a distance to the one or more shipping containers or one or more open parking spots; and calculating a second location of the one or more shipping containers or one or more open parking spots, wherein the second location is based on the first location of the locator device and the distance to the one or more shipping containers or one or more open parking spots.

Aspect 9. The method of Aspect 8, wherein the remote sensor is a Light Detection and Ranging (LiDAR) sensor.

Aspect 10. The method of any of Aspects 8-9, wherein the one or more PNT sensors comprises at least one of an inertial measurement unit (IMU), a Global Navigation Satellite System (GNSS) receiver, or a combination thereof.

Aspect 11. The method of any of Aspects 8-10, wherein the locator device is attached to a yard rig.

Aspect 12. The method of any of Aspects 8-11, wherein the locator device is attached to a drone.

Aspect 13. The method of any of Aspects 8-12, further comprising: transmitting, using a communication system, the identification and the second location of the one or more shipping containers or open parking spots to a remote location.

Aspect 14. The method of any of Aspects 8-13, wherein the camera is mounted on an electronically controllable mechanical gimbal.

Aspect 15. A non-transitory computer-readable storage medium comprising at least one instruction for causing a computer or processor to: determine, using a camera, an identification of one or more shipping containers or one or more open parking spots; calculate, using one or more position, navigation, and timing (PNT) sensors, a first location of a locator device; determine, using the camera and a remote sensor, a distance to the one or more shipping containers or one or more open parking spots; and calculate a second location of the one or more shipping containers or one or more open parking spots, wherein the second location is based on the first location of the locator device and the distance to the one or more shipping containers or one or more open parking spots.

Aspect 16. The non-transitory computer-readable storage medium of Aspect 15, wherein the remote sensor is a Light Detection and Ranging (LiDAR) sensor.

Aspect 17. The non-transitory computer-readable storage medium of any of Aspects 15-16, wherein the one or more PNT sensors comprises at least one of an inertial measurement unit (IMU), a Global Navigation Satellite System (GNSS) receiver, or a combination thereof.

Aspect 18. The non-transitory computer-readable storage medium of any of Aspects 15-17, wherein the locator device is attached to a yard rig.

Aspect 19. The non-transitory computer-readable storage medium of any of Aspects 15-18, wherein the locator device is attached to a drone.

Aspect 20. The non-transitory computer-readable storage medium of any of Aspects 15-19, wherein the at least one instruction is further configured to: transmit, using a communication system, the identification and the second location of the one or more shipping containers or open parking spots to a remote location.

The various examples described above are provided by way of illustration only and should not be construed to limit the scope of the disclosure. For example, the principles herein apply equally to optimization as well as general improvements. Various modifications and changes may be made to the principles described herein without following the example examples and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A system comprising:
at least one memory; and
at least one processor coupled to the at least one memory, the at least one processor configured to:
determine, using a camera, an identification of one or more shipping containers or
one or more open parking spots;
calculate, using one or more position, navigation, and timing (PNT) sensors, a first location of a locator device;
determine, using the camera and a remote sensor, a distance to the one or more shipping containers or one or more open parking spots; and
calculate a second location of the one or more shipping containers or one or more open parking spots, wherein the second location is based on the first location of the locator device and the distance to the one or more shipping containers or one or more open parking spots.

2. The system of claim 1, wherein the remote sensor is a Light Detection and Ranging (LiDAR) sensor.

3. The system of claim 1, wherein the one or more PNT sensors comprises at least one of an inertial measurement unit (IMU), a Global Navigation Satellite System (GNSS) receiver, or a combination thereof.

4. The system of claim 1, wherein the locator device is attached to a yard rig.

5. The system of claim 1, wherein the locator device is attached to a drone.

6. The system of claim 1, wherein the at least one processor is further configured to:
transmit, using a communication system, the identification and the second location of the one or more shipping containers or open parking spots to a remote location.

7. The system of claim 1, wherein the camera is mounted on an electronically controllable mechanical gimbal.

8. A method comprising:
determining, using a camera, an identification of one or more shipping containers or one or more open parking spots;
calculating, using one or more position, navigation, and timing (PNT) sensors, a first location of a locator device;
determining, using the camera and a remote sensor, a distance to the one or more shipping containers or one or more open parking spots; and
calculating a second location of the one or more shipping containers or one or more open parking spots, wherein the second location is based on the first location of the locator device and the distance to the one or more shipping containers or one or more open parking spots.

9. The method of claim 8, wherein the remote sensor is a Light Detection and Ranging (LiDAR) sensor.

10. The method of claim 8, wherein the one or more PNT sensors comprises at least one of an inertial measurement unit (IMU), a Global Navigation Satellite System (GNSS) receiver, or a combination thereof.

11. The method of claim 8, wherein the locator device is attached to a yard rig.

12. The method of claim 8, wherein the locator device is attached to a drone.

13. The method of claim 8, further comprising:
transmitting, using a communication system, the identification and the second location of the one or more shipping containers or open parking spots to a remote location.

14. The method of claim 8, wherein the camera is mounted on an electronically controllable mechanical gimbal.

15. A non-transitory computer-readable storage medium comprising at least one instruction for causing a computer or processor to:
determine, using a camera, an identification of one or more shipping containers or one or more open parking spots;
calculate, using one or more position, navigation, and timing (PNT) sensors, a first location of a locator device;
determine, using the camera and a remote sensor, a distance to the one or more shipping containers or one or more open parking spots; and
calculate a second location of the one or more shipping containers or one or more open parking spots, wherein the second location is based on the first location of the locator device and the distance to the one or more shipping containers or one or more open parking spots.

16. The non-transitory computer-readable storage medium of claim 15, wherein the remote sensor is a Light Detection and Ranging (LiDAR) sensor.

17. The non-transitory computer-readable storage medium of claim 15, wherein the one or more PNT sensors comprises at least one of an inertial measurement unit (IMU), a Global Navigation Satellite System (GNSS) receiver, or a combination thereof.

18. The non-transitory computer-readable storage medium of claim 15, wherein the locator device is attached to a yard rig.

19. The non-transitory computer-readable storage medium of claim 15, wherein the locator device is attached to a drone.

20. The non-transitory computer-readable storage medium of claim 15, wherein the at least one instruction is further configured to:
transmit, using a communication system, the identification and the second location of the one or more shipping containers or open parking spots to a remote location.
